(19) United States
(12) Patent Application Publication
(10) Pub. No.: US 2026/0223013 A1
(43) Pub. Date: Jul. 30, 2026

(54) TECHNIQUES FOR ALLOWED TOTAL POWER REDUCTION

(71) Applicant: Lenovo (United States) Inc., Morrisville, NC (US)

(72) Inventor: Colin Frank, Park Ridge, IL (US)

(21) Appl. No.: 19/038,521

(22) Filed: Jan. 27, 2025

(51) Int. Cl. H04W 52/36; H04B 17/354; H04W 24/08; H04W 72/0453

(52) U.S. Cl. CPC H04W 52/367; H04B 17/354; H04W 24/08; H04W 72/0453

(57) ABSTRACT

Various aspects of the present disclosure relate to techniques for allowed total power reduction. An apparatus is configured to define an extended channel bandwidth for a user equipment (UE); determine one or more channel emissions constraints associated with the extended channel bandwidth; determine an additional emissions constraint; define a maximum power reduction (MPR) for one or more transmissions based on the extended channel bandwidth and the one or more channel emissions constraints and an additional MPR (A-MPR) based on the additional emissions constraint; and communicate in accordance with the MPR and the A-MPR for the one or more transmissions.

### TECHNICAL FIELD

The present disclosure relates to wireless communications, and more specifically to techniques (e.g., methods, designs) for allowed total power reduction.

### BACKGROUND

A wireless communications system may include one or multiple network communication devices, such as base stations, which may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A user equipment (UE) for wireless communication is described. The UE may be configured to, capable of, or operable to define an extended channel bandwidth for the UE; determine one or more channel emissions constraints associated with the extended channel bandwidth; determine an additional emissions constraint; define a maximum power reduction (MPR) for one or more transmissions based on the extended channel bandwidth and the one or more channel emissions constraints and an additional MPR (A-MPR) based on the additional emissions constraint; and communicate in accordance with the MPR and the A-MPR for the one or more transmissions.

A method for wireless communication performed by a UE. The method may be configured to define an extended channel bandwidth for the UE; determine one or more channel emissions constraints associated with the extended channel bandwidth; determine an additional emissions constraint; define a MPR for one or more transmissions based on the extended channel bandwidth and the one or more channel emissions constraints and an A-MPR based on the additional emissions constraint; and communicate in accordance with the MPR and the A-MPR for the one or more transmissions.

A processor for wireless communication is described. The processor may be configured to, capable of, or operable to define an extended channel bandwidth for the UE; determine one or more channel emissions constraints associated with the extended channel bandwidth; determine an additional emissions constraint; define a MPR for one or more transmissions based on the extended channel bandwidth and the one or more channel emissions constraints and an A-MPR based on the additional emissions constraint; and communicate in accordance with the MPR and the A-MPR for the one or more transmissions.

A network equipment (NE) for wireless communication is described. The NE may be configured to, capable of, or operable to determine an allowed MPR for a UE based on an extended channel bandwidth; determine an allowed A-MPR for the UE based on additional emissions constraints; determine a lower bound on a maximum configured power for a resource block allocation based on the allowed MPR and the allowed A-MPR; and communicate the lower bound on the maximum configured power for the resource block allocation.

A method for wireless communication performed by a NE. The method may be configured to determine an allowed MPR for a UE based on an extended channel bandwidth; determine an allowed A-MPR for the UE based on additional emissions constraints; determine a lower bound on a maximum configured power for a resource block allocation based on the allowed MPR and the allowed A-MPR; and communicate the lower bound on the maximum configured power for the resource block allocation.

A processor for wireless communication is described. The processor may be configured to, capable of, or operable to determine an allowed MPR for a UE based on an extended channel bandwidth; determine an allowed A-MPR for the UE based on additional emissions constraints; determine a lower bound on a maximum configured power for a resource block allocation based on the allowed MPR and the allowed A-MPR; and communicate the lower bound on the maximum configured power for the resource block allocation.

### BRIEF DESCRIPTION OF THE DRAWINGS

FIG. 1 illustrates an example of a wireless communications system, in accordance with aspects of the present disclosure.

FIG. 2A illustrates an example of possible configurations of an extended channel bandwidth, in accordance with aspects of the present disclosure.

FIG. 2B illustrates an example of possible configurations of an extended channel bandwidth, in accordance with aspects of the present disclosure.

FIG. 3 illustrates other examples of extended channel bandwidths, in accordance with aspects of the present disclosure.

FIG. 4 illustrates an embodiment of an extended bandwidth, in accordance with aspects of the present disclosure.

FIG. 5 illustrates an embodiment of an uplink spectrum, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment in accordance with aspects of the present disclosure.

FIG. 9 illustrates a flowchart of a method in accordance with aspects of the present disclosure.

FIG. 10 illustrates a flowchart of a method in accordance with aspects of the present disclosure.

### DETAILED DESCRIPTION

Wireless communications networks, such as fifth generation (5G) new radio (NR), can coexist peacefully with adjacent cellular bands and sometimes in the same spectrum as other wireless communications systems such as Wi-Fi, CBRS (citizens broadband radio service), military and satellite services. In certain embodiments, relaxing the co-existence requirements may reduce a UE's allowed maximum power reduction (MPR) and increase uplink coverage in certain scenarios.

The relaxed co-existence requirements can exist in several scenarios. For instance, in an example scenario, the operator's contiguous bandwidth in a band is wider than the maximum channel bandwidth supported in the specification. In another example scenario, the operator's contiguous bandwidth is wider than the channel bandwidth configured by the operator. In one scenario, the UE channel bandwidth is narrower than the channel bandwidth configured by the operator (e.g., in the case of a reduced capability device). In another scenario, there is no co-existence requirement adjacent to the operator's spectrum.

These scenarios may be summarized as follows:
Scenario 1-1: Scenario with no adjacent in-band/out-of-band co-existence issue (single operator).
Scenario 1-2: Scenario with no adjacent in-band/out-of-band co-existence issue (adjacent operators).
Scenario 2: Narrower UE channel bandwidth within wider base station bandwidth.

In general, more MPR is allowed and needed for resource block (RB) allocations for which the second order intermodulation (IM) products of the RB allocation overlap with the region adjacent to the carrier in which adjacent channel leakage ratio (ACLR) requirements apply. By defining an extended channel bandwidth for the UE and moving the region in which ACLR requirements apply further away from the UE channel bandwidth, fewer RB allocations will require the larger MPR needed to meet the ACLR requirements.

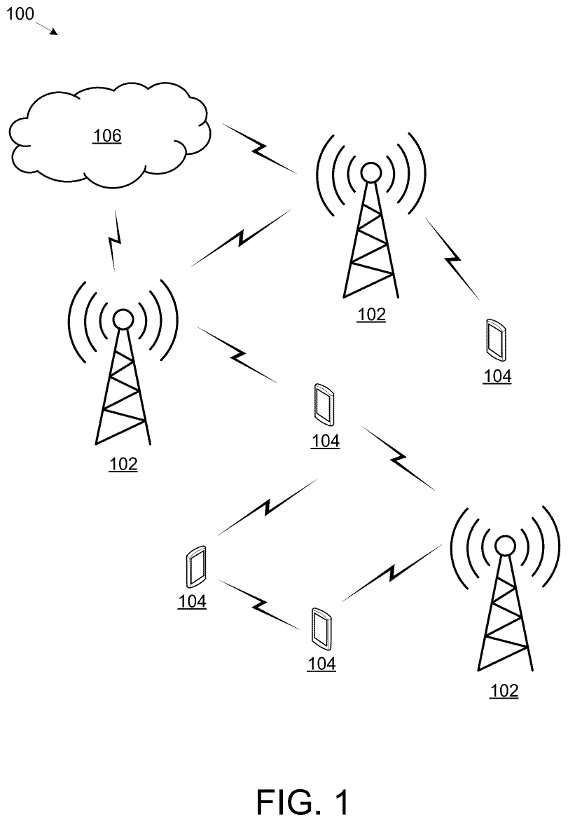

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one embodiment, the system 100 shown in FIG. 1 is configured to, capable or, or operable to create a precoding matrix for enabling a plurality of combinations of streams of multiplexed layers at a plurality of receiving antennas, wherein the plurality combinations of streams are associated with a plurality of user equipment UEs; transmit the precoding matrix to the plurality of UEs associated with the multiplexed layers; detect a plurality of signals at the plurality of receiving antennas using a factor graph-based detection algorithm, wherein the plurality of signals are encoded using the precoding matrix; and decode the plurality of signals based at least in part on the precoding matrix.

As described above, more MPR is allowed and needed for RB allocations for which the second order IM products of the RB allocation overlap with the region adjacent to the carrier in which ACLR requirements apply. By defining an extended channel bandwidth for the UE and moving the region in which ACLR requirements apply further away from the UE channel bandwidth, fewer RB allocations will require the larger MPR needed to meet the ACLR requirements.

The MPR allowed for the power class 3 is given in the table below (from 3GPP TS 38.101-1, incorporated herein by reference). Similar tables apply for other UE power classes.

| | | MPR (dB) | | |
|---|---|---|---|---|
| | | Edge RB | Outer RB | Inner RB |
| Modulation | | allocations | allocations | allocation |
| DFT-s- | Pi/2 BPSK | ≤3.5¹ | ≤1.2¹ | ≤0.2¹ |
| OFDM | | ≤0.5^{2,3} | ≤0.5² | 0² |
| | Pi/2 BPSK w Pi/2 | ≤0.5^{2,3} | 0² | 0² |
| | BPSK DMRS | | | |

| | QPSK | ≤1 | 0 |
|---|---|---|---|
| | 16 QAM | ≤2 | ≤1 |
| | 64 QAM | ≤2.5 | |
| | 256 QAM | ≤4.5 | |
| CP-OFDM | QPSK | ≤3 | ≤1.5 |
| | 16 QAM | ≤3 | ≤2 |

| | |
|---|---|
| 64 QAM | ≤3.5 |
| 256 QAM | ≤6.5 |

NOTE:
¹Applicable for UE operating in TDD mode with Pi/2 BPSK modulation and UE indicates support for UE capability powerBoosting-pi2BPSK and if the IE powerBoostPi28PSK is set to 1 and 40% or less slots in radio frame are used for UL transmission for bands n40, n41, n77, n78 and n79. The reference power of 0 dB MPR is 26 dBm.
NOTE:
²Applicable for conditions where note 1 does not apply.
NOTE:
³For 3 MHz channel bandwidth the Pi/2 BPSK edge allocation MPR is 1 dB

For a contiguous resource block allocation of L_{CRB} RB's, the inner, outer, and edge RB allocations are defined in the following (e.g., from TS 38.101-1):

The following parameters are defined to specify valid RB allocation ranges for outer and inner RB allocations. N_{RB} is the maximum number of RBs for a given channel bandwidth and sub-carrier spacing. RB_{Start,Low}=max(1, floor(L_{CRB}/2)) where max( ) indicates the largest value of all arguments and floor(x) is the greatest integer less than or equal to x. RB_{Start,High}=N_{RB}−RB_{Start,Low}−L_{CRB}. The RB allocation is an inner RB allocation if the following conditions are met. RB_{Start,Low}≤RB_{Start}≤RB_{Start,High}, and L_{CRB}≤ceil(N_{RB}/2) where ceil(x) is the smallest integer greater than or equal to x.

An edge RB allocation is the one for which the RB(s) is (are) allocated at the lowermost or uppermost edge of the channel L_{CRB}≤2 RBs, except for PC1 UE supporting other bands than n14.

The RB allocation is an outer RB allocation for all other allocations which are not an Inner RB allocation or Edge RB allocation.

The larger MPR allowed for the outer region is necessary to meet the ACLR given in the following table (e.g., from 3GPP TS 38.101-1):

| | Power | Power | Power | Power |
|---|---|---|---|---|
| | class 1 | class 1.5 | class 2 | class 3 |
| NR ACLR | 37 dB | 31 dB | 31 dB | 30 dB |

NOTE 1:
Void

The ACLR is not the only emissions constraint placed on the UE when transmitting. The emissions constraints may include the ACLR requirement, the in-band emissions requirements, the spectral emissions mask, and the spurious emissions domain.

The in-band emissions requirements apply to RBs within the UE transmission bandwidth that are not used for transmission. The purpose of the in-band emissions constraint is to avoid interfering with the UE's transmitting on the other RBs. The purpose of the constraints on the spectrum emissions mask and the spurious emissions domain are to avoid interfering with users in other channels and bands. The emissions constraints are defined below:

| Parameter | | | | Applicable |
|---|---|---|---|---|
| description | Unit | Limit (NOTE 1) | | Frequencies |
| General | dB | max{−25 − 10 · log₁₀ (N_{RB}/L_{CRB}), | | Any non- |
| | | 20 · log₁₀ EVM − 3 − 5 · (\|Δ_{RB}\| − 1)/ | | allocated |
| | | L_{CRB}, −57 dBm + 10 log₁₀ (SCS/15 kHz) − P̅_̅{̅R̅B̅}̅} | | (NOTE 2) |
| IQ Image | dB | −28 | Image frequencies when output | Image |
| | | | power > 10 dBm | frequencies |
| | | −25 | Image frequencies when output | (NOTES 2, 3) |
| | | | power ≤ 10 dBm | |
| Carrier | dBc | −28 | Output power > 10 dBm | Carrier |
| leakage | | −25 | 0 dBm ≤ Output power ≤ 10 dBm | leakage |
| | | −20 | −30 dBm ≤ Output power < 0 dBm | frequency |
| | | −10 | −40 dBm ≤ Output power < −30 dBm | (NOTES 4, 5) |

(NOTE 1):
An in-band emissions combined limit is evaluated in each non-allocated RB. For each such RB, the minimum requirement is calculated as the higher of P̅_̅{̅R̅B̅}̅ - 30 dB and the power sum of all limit values (General, IQ Image or Carrier leakage) that apply. P̅_̅{̅R̅B̅}̅ is defined in NOTE 10.
(NOTE 2):
The measurement bandwidth is 1 RB and the limit is expressed as a ratio of measured power in one non-allocated RB to the measured average power per allocated RB, where the averaging is done across all allocated RBs. For pi/2 BPSK with Spectrum Shaping, the limit is expressed as a ratio of measured power in one non-allocated RB to the measured power in the allocated RB with highest PSD.
(NOTE 3):
The applicable frequencies for this limit are those that are enclosed in the reflection of the allocated bandwidth, based on symmetry with respect to the carrier leakage frequency, but excluding any allocated RBs.
(NOTE 4):
The measurement bandwidth is 1 RB and the limit is expressed as a ratio of measured power in one non-allocated RB to the measured total power in all allocated RBs.
(NOTE 5):
The applicable frequencies for this limit depend on the parameter txDirectCurrentLocation in UplinkTxDirectCurrent IE, and are those that are enclosed either in the RB containing the carrier leakage frequency, or in the two RBs immediately adjacent to the carrier leakage frequency but excluding any allocated RB.
NOTE 6:
L_{CRB} is the Transmission Bandwidth (see clause 5.3).
NOTE 7:
N_{RB} is the Transmission Bandwidth Configuration (see clause 5.3).
NOTE 8:
EVM is the limit specified in Table 6.4.2.1-1 for the modulation format used in the allocated RBs.
NOTE 9:
Δ_{RB} is the starting frequency offset between the allocated RB and the measured non-allocated RB (e.g. Δ_{RB} = 1 or Δ_{RB} = −1 for the first adjacent RB outside of the allocated bandwidth.
NOTE 10:
P̅_̅{̅R̅B̅}̅ is an average of the transmitted power over 10 sub-frames normalized by the number of allocated RBs, measured in dBm.
NOTE 11:
For almost contiguous allocations defined in clause 6.2.2, L_{CRB} = N_{RB}_{_{—}}_{alloc} + N_{RB}_{_{—}}_{gap} with no in-gap emission requirement.

### In Band Emissions Requirements

| | Channel bandwidth (MHz)/ | | | | | |
|---|---|---|---|---|---|---|
| | Spectrum emission limit (dBm) | | | | | |
| | | | 10, 15, 20, 25, | 50, 60, 70, 80, | Measurement | |
| Δf_{OOB} (MHz) | 3 | 5 | 30, 35, 40, 45 | 90, 100 | bandwidth | |
| ±0-1 | −13 | −13 | −13 | | 1% of channel BW | |
| ±0-1 | | | | −24 | 30 | kHz |

| | | | | | |
|---|---|---|---|---|---|
| ±1-5 | −10 | −10 | −10 | 1 | MHz |

| ±5-6 | −25 | −13 | |
|---|---|---|---|
| ±6-10 | | −25 | |
| ±5-BW_{Channel} | | | −13 |
| ±BW_{Channel}_{^{−}} | | | −25 |
| (BW_{Channel} + 5) | | | |

### Spectrum Emission Mask

| Channel bandwidth | OOB boundary F_{OOB} (MHz) |
|---|---|
| 3 | 6 |
| 5, 10, 15, 20, 25, | BW_{Channel} + 5 |
| 30, 35, 40, 45, 50, | |
| 60, 70, 80, 90, 100 | |

### Boundary Between NR Out of Band and General Spurious Emission Domain

| | Maximum | Measurement | | |
|---|---|---|---|---|
| Frequency Range | Level | bandwidth | | NOTE |
| 9 kHz ≤ f < 150 kHz | −36 dBm | 1 | kHz | |
| 150 kHz ≤ f < 30 MHz | −36 dBm | 10 | kHz | |
| 30 MHz ≤ f < 1000 MHz | −36 dBm | 100 | kHz | |
| 1 GHz ≤ f < 12.75 GHz | −30 dBm | 1 | MHz | 4 |
| | −25 dBm | 1 | MHz | 3 |
| 12.75 GHz ≤ f < 5^{th} harmonic | −30 dBm | 1 | MHz | 1 |
| of the upper frequency edge | | | | |
| of the UL operating band in | | | | |
| GHz | | | | |
| 12.75 GHz < f < 26 GHz | −30 dBm | 1 | MHz | 2 |

NOTE 1:
Applies for Band for which the upper frequency edge of the UL Band is greater than 2.55 GHz and less than or equal to 5.2 GHz
NOTE 2:
Applies for Band that the upper frequency edge of the UL Band more than 5.2 GHz
NOTE 3:
Applies for Band n41, CA configurations including Band n41, and EN-DC configurations that include n41 specified in clause 5.2B of TS 38.101-3 when NS_04 is signalled.
NOTE 4:
Does not apply for Band n41, CA configurations including Band n41, and EN-DC configurations that include n41 specified in subclause 5.2B of TS 38.101-3 when NS_04 is signalled.

### Requirement for General Spurious Emissions Limits

By defining an extended channel bandwidth for the UE and moving the region in which ACLR requirements away from the UE channel bandwidth, some or all of the outer and edge RB allocations can be converted to inner RB allocations for which less MPR is allowed.

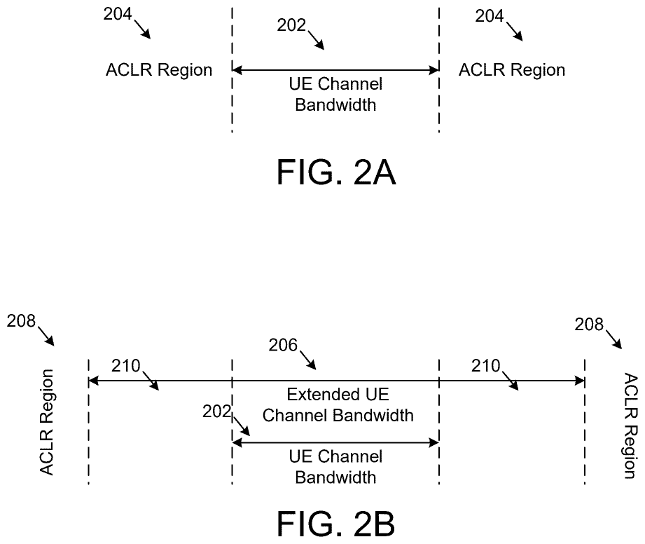

FIGS. 2A and 2B illustrate examples of possible configurations of an extended channel bandwidth, in accordance with aspects of the present disclosure. The UE channel bandwidth 202 is shown in FIG. 2A. The region 204, in which the ACLR requirement applies, is immediately adjacent to the UE channel bandwidth 202. The extended channel bandwidth 206 is shown in FIG. 2B for which the ACLR requirement is moved to the region 208 immediately adjacent to the extended channel bandwidth 206. It should be noted that the extended channel bandwidth 206 is used for determining emissions requirements and the allowed MPR and that the RBs transmitted by the UE are limited to the UE channel bandwidth 202.

In FIG. 2B, the extended UE channel bandwidth 206 is symmetrically extended relative to the UE channel bandwidth 202 and the extension 210 on each side is equal to one-half the UE channel bandwidth 202. This bandwidth extension 210 is the minimum bandwidth extension sufficient to convert all outer RB allocations to inner RB allocations for which less MPR is allowed; however, other scenarios are possible.

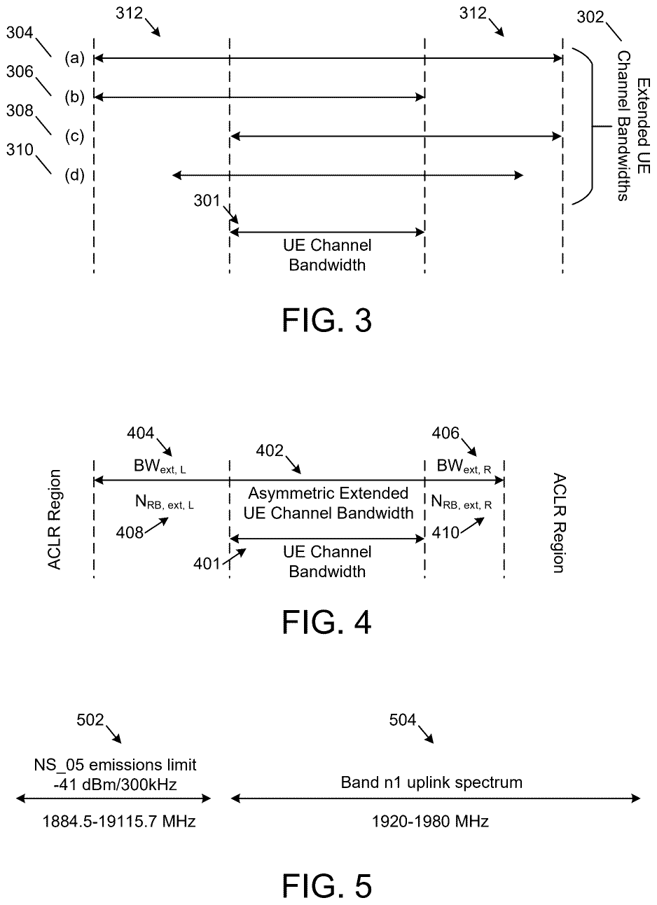

FIG. 3 illustrates other examples of extended channel bandwidths 302, in accordance with aspects of the present disclosure. In FIG. 3, case (a) 304 corresponds to the same extended channel bandwidth 206 as in FIG. 2B in which the extension 312 is symmetric on each side of the UE channel bandwidth 301 and is equal to one-half of the UE channel bandwidth 301. Cases (b) 306 and (c) 308 show examples in which the extended channel bandwidth 302 is only extended on one side of the UE channel bandwidth 301, with the bandwidth expansion 312 to the left in case (b) 306 and bandwidth expansion 312 to the right in case (c) 308. In both case (b) 306 and case (c) 308, the bandwidth expansion 312 is equal to one-half of the UE channel bandwidth 301. In case (d) 310, the bandwidth is extended on both sides of the UE channel bandwidth 301, and the bandwidth extension 312 on the left is not equal to the bandwidth extension 312 on the right (this is the most general case).

The ACLR requirement can be applied from the edges of the extended channel bandwidth. That is, the adjacent channel leakage power can be measured over a bandwidth beginning at the edges of the extended channel bandwidth and extending the measurement bandwidth outside of the extended channel bandwidth. Separate measurements may be taken above and below the extended channel bandwidth. There may be two options for the ACLR measurement bandwidth—the first is the UE channel bandwidth, and the second is the extended channel bandwidth. The UE should easily meet the ACLR using either of these bandwidths since the filter bandwidth used by the UE for transmission will correspond to the UE channel bandwidth and not the extended channel bandwidth.

Fundamentally, it should be possible to keep the other emissions requirements unchanged, including the in-band emissions requirement, the spectral emissions mask, and the spurious emissions requirements, since all of these other existing requirements can be met with the MPR allowed for inner RB allocations. Relaxation of the emissions requirements other than the ACLR may not allow for any additional reduction of MPR and may thus be unnecessary and of no benefit.

In one embodiment, the “inner” RB region is defined in the specification such that the second order intermodulation products of the RB allocation are contained within the UE channel bandwidth, excluding the guard band. Let N_{RB} denote the maximum number of RB's that can be transmitted within the UE channel bandwidth and let the RB indices be indexed within the interval [0, N_{RB}−1]. Let L_{CRB} denote the number of allocated RBs in a contiguous RB allocation. The inner RB allocations may be defined such that the first RB of the allocation RB_{Start} satisfies RB_{Start,Low}≤RB_{Start}≤RB_{Start,High} where RB_{Start,Low}=max(1, floor(L_{CRB}/2)) and RB_{Start,High}=N_{RB}−RB_{Start,Low}−L_{CRB}.

An edge RB allocation is the one for which the RB(s) is (are) allocated at the lowermost or uppermost edge of the channel L_{CRB}≤2 RBs, except for PC1 UE supporting other bands than n14. The RB allocation is an Outer RB allocation for all other allocations which are not an inner RB allocation or edge RB allocation.

FIG. 4 illustrates an embodiment of an extended bandwidth 402, in accordance with aspects of the present disclosure. For an extended channel bandwidth 402, let BW_{ext,L} 404 and BW_{ext,R} 406, respectively, denote the bandwidth extension to the left and right of the UE channel bandwidth 401. Let N_{RB,ext,L} 408 and N_{RB,ext,R} 410 denote the corresponding number of virtual RBs that can be added to the left and right of the UE channel bandwidth 401 within this bandwidth using the same subcarrier spacing and maintaining the required minimum guard bands at the edges of the extended channel bandwidth.

With this left 404 and right 406 bandwidth extension, the inner, outer, and edge regions for a contiguous RB allocation of L_{CRB} RBs can be redefined. For instance, the inner RB allocations are defined such that the first RB of the RB allocation RB_{Start} satisfies RB_{Start,Low}≤RB_{Start}≤RB_{Start,High} where RB_{Start,Low}=max(max(1, floor(L_{CRB}/2))−N_{RB,ext,L}, 0) and RB_{Start,High}=min(min(N_{RB}−L_{CRB}−floor(L_{CRB}/2), N_{RB}−2)+N_{RB,ext,R}, N_{RB}−L_{CRB}).

In the case that N_{RB,ext,L}≥ceil(N_{RB}/2), RB_{Start,Low}=0. In the case that N_{RB,ext,R}≥ceil(N_{RB}/2), RB_{Start_High}=N_{RB}−L_{CRB}. In the case that N_{RB,ext,L}≥ceil(N_{RB}/2) and N_{RB,ext,R}≥ceil(N_{RB}/2), then all RB allocations are inner allocations. An Edge RB allocation is the one for which N_{RB,ext,L}=0, RB_{Start}=0, and L_{CRB}≤2 RBs, or for which N_{RB,ext,R}=0, RB_{Start}=N_{RB}−1, and L_{CRB}=1 RB, or for which N_{RB,ext,R}=0, RB_{Start}=N_{RB}−2, and L_{CRB}=2 RB's, except for PC1 UE supporting other bands than n14. The RB allocation is an outer RB allocation for other allocations that are not an inner RB allocation or an edge RB allocation.

Alternatively, the inner, outer, and edge regions can be defined where N_{RB,Extended}=N_{RB}+N_{RB,ext,L}+N_{RB,ext,R}. The RB allocation is an inner RB allocation if RB_{Start,Low,Extended}≤RB_{Start}+N_{RB,ext,L}≤RB_{Start,High,Extended} where RB_{Start,Low,Extended}=max(1, floor(L_{CRB}/2)), where max( ) indicates the largest value of all arguments, floor(x) is the greatest integer less than or equal to x, and RB_{Start,High,Extended}=N_{RB,Extended}−RB_{Start,Low,Extended}−L_{CRB}. An Edge RB allocation is the one for which N_{RB,ext,L}=0, RB_{Start}=0, and L_{CRB}≤2 RBs, or for which N_{RB,ext,R}=0, RB_{Start}=N_{RB}−1, and L_{CRB}=1 RB, or for which N_{RB,ext,R}=0, RB_{Start}=N_{RB}−2, and L_{CRB}=2 RB's, except for PC1 UE supporting other bands than n14. The RB allocation is an outer RB allocation for other allocations that are not an inner RB allocation or an edge RB allocation.

Thus, by using an extended channel bandwidth, some set of RB allocations can be converted from outer allocations to inner allocations, and the allowed MPR will be decreased, e.g., as indicated in TS 38.101-1, Table 6.2.2-1. The set of RB allocations that are converted from outer allocations to inner allocations will depend on the values of N_{RB}, N_{RB,ext,L} 408 and N_{RB,ext,R} 410.

In some cases, additional network signaled (NS) emission requirements can apply. For instance, TS 38.101-1, Table 6.2.3.1-1 indicates the NS signaling defined for each band along with the corresponding tables defining the corresponding emissions requirements and the allowed A-MPR.

| Network | | | Channel | Resources | |
|---|---|---|---|---|---|
| signalling | Requirements | | bandwidth | blocks | A-MPR |
| label | (clause) | NR Band | (MHz) | (N_{RB}) | (dB) |
| NS_01 | | Table 5.2-1 | 3, 5, 10, 15, 20, | Table | N/A |
| | | (NOTE 8) | 25, 30, 35, 40, | 5.3.2-1 | |
| | | | 45, 50, 60, 70, | | |
| | | | 80, 90, 100 | | |
| NS_03 | 6.5.2.3.3 | n2, n25, n66, | | | Clause |
| | | n70, n86 | | | 6.2.3.7 |
| NS_03U | 6.5.2.3.3, | n2, n25, n66, | | | Clause |
| | 6.5.2.4.2 | n86 | | | 6.2.3.7 |
| | | (NOTE 1) | | | |
| NS_04 | 6.5.2.3.2, | n41, n90 | 5, 10, 15, 20, 25, | | Clause |
| | 6.5.3.3.1 | | 30, 35, 40, 45, | | 6.2.3.2 |
| | | | 50, 60, 70, 80, | | |
| | | | 90, 100 | | |
| NS_05 | 6.5.3.3.4 | n1, n65, n84 | 5, 10, 15, 20 | | Clause |
| | | (NOTE 1) | (NOTE 2) | | 6.2.3.4 |
| | | | | | (NOTE 7) |
| NS_05U | 6.5.3.3.4, | n1, n65, n84 | 5, 10, 15, 20 | | Clause |
| | 6.5.2.4.2 | | | | 6.2.3.4 |
| | | | | | (NOTE 7) |
| NS_06 | 6.5.2.3.4 | n12¹³, n85 | 3, 5, 10, 15 | | Clause |
| | | n14 | 5, 10 | | 6.2.3.32¹² |
| NS_07 | 6.5.2.3.4 | n13 | 5, 10 | Table | Table |
| | 6.5.3.3.26 | | | 6.2.3.29-1 | 6.2.3.29-2 |
| NS_10 | | n20, n82 | 15, 20 | Table | Table |
| | | | | 6.2.3.3-1 | 6.2.3.3-1 |
| NS_12 | 6.5.3.3.17 | n26 | 3, 5, 10 | Table | Table |
| | | | | 6.2.3.21-1 | 6.2.3.21-2 |
| NS_13 | 6.5.3.3.18 | n26 | 3, 5 | Table | Table |
| | | | | 6.2.3.22-1 | 6.2.3.22-2 |
| NS_14 | 6.5.3.3.19 | n26 | 10, 15, 20 | Table | Table |
| | | | | 6.2.3.23-1 | 6.2.3.23-2 |
| NS_15 | 6.5.3.3.20 | n26 | 3, 5, 10, 15, 20 | Table | Table |
| | | | | 6.2.3.24-1 | 6.2.3.24-2 |
| NS_17 | 6.5.3.3.2 | n28, n83¹³ | 3, 5, 10 | Table | N/A |
| | | | | 5.3.2-1 | |
| NS_18 | 6.5.3.3.3 | n28, n83¹³ | 3, 5 | | Table |
| | | | | | 6.2.3.13-1, |
| | | | | | A1 |
| | | | 10, 15, 20 | | Table |
| | | | | | 6.2.3.13-1, |
| | | | | | A2 |
| | | | 25, 30 | | Table |
| | | | | | 6.2.3.13-1, |
| | | | | | A3, A4, A5 |
| NS_21 | 6.5.2.3.9 | n30 | 5, 10 | | Clause |
| | 6.5.3.3.12 | | | | 6.2.3.14 |
| NS_24 | 6.5.3.3.13 | n65 | 5, 10, 15, 20 | Table | Clause |
| | | (NOTE 4) | | 6.2.3.15-1 | 6.2.3.15 |
| NS_27 | 6.5.2.3.8 | n48 | 5, 10, 15, 20, | Table | Table |
| | 6.5.3.3.14 | | 30, 40 | 6.2.3.16-1 | 6.2.3.16-2 |
| NS_35 | 6.5.2.3.1 | n71 | 5, 10, 15, 20, | Table | Clause |
| | | (NOTE 11) | 25, 30 | 5.3.2-1 | 6.2.3.3111 |
| NS_37 | 6.5.3.3.6 | n74 | 10, 15 | Table | Table |
| | | (NOTE 3) | | 6.2.3.8-1 | 6.2.3.8-1 |
| NS_38 | 6.5.3.3.7 | n74 | 5, 10, 15, 20 | Table | Table |
| | | | | 6.2.3.9-1 | 6.2.3.9-1 |
| NS_39 | 6.5.3.3.8 | n74 | 10, 15, 20 | Table | Table |
| | | | | 6.2.3.10-1 | 6.2.3.10-1 |
| NS_40 | 6.5.3.3.9 | n51 | 5 | | Table |
| | | | | | 6.2.3.5-1 |
| NS_41 | 6.5.3.3.10 | n50 | 5, 10, 15, 20, 30, | | Table |
| | | | 40, 50, 60 | | 6.2.3.11-1 |
| NS_42 | 6.5.3.3.11 | n50 | 5, 10, 15, 20, 30, | | Table |
| | | | 40, 50, 60 | | 6.2.3.12-1 |
| NS_43 | 6.5.3.3.5 | n8, n81 | 5, 10, 15 | | Clause |
| | | | | | 6.2.3.6 |
| NS_43U | 6.5.3.3.5, | n8, n81 | 5, 10, 15 | | Clause |
| | 6.5.2.4.2 | (NOTE 1) | | | 6.2.3.6 |
| NS_44 | 6.5.3.3.24 | n38 | 25, 30, 40 | Table | Table |
| | | | | 6.2.3.20-1 | 6.2.3.20-1 |
| NS_45 | 6.5.3.3.21 | n53 | 5, 10 | | Clause |
| | | | | | 6.2.3.25 |
| NS_46 | 6.5.3.3.25 | n7 | 25, 30, 35, | Table | Table |
| | | | 40, 50 | 6.2.3.17-1 | 6.2.3.17-2 |
| NS_47 | 6.5.3.3.15 | n41 | 30 | Table | Table |
| | | (Note 5) | | 6.2.3.18-1 | 6.2.3.18-2 |
| NS_48 | 6.5.3.3.22 | n1 and n84 | 10, 15, 20, 25, | Table | Table |
| | | | 30, 40, 45, 50 | 6.2.3.26-1, | 6.2.3.26-2, |
| | | | | Table | Table |
| | | | | 6.2.3.26-3 | 6.2.3.26-4 |
| | | | | | (NOTE 7) |
| NS_49 | 6.5.3.3.23 | n1 and n84 | 10, 15, 20, 25, | Table | Table |
| | | | 30, 40, 45, 50 | 6.2.3.27-1, | 6.2.3.27-2, |
| | | | | Table | Table |
| | | | | 6.2.3.27-3 | 6.2.3.27-4 |
| | | | | | (NOTE 7) |
| NS_50 | 6.5.3.3.16 | n39, n98 | 10, 15, 20, 25, | | Clause |
| | | | 30, 35, 40 | | 6.2.3.19 |
| NS_51 | 6.5.3.3.22 | n65 | 50 | Table | Table |
| | | | | 6.2.3.28-1 | 6.2.3.28-2 |
| NS_55 | NOTE 6 | n77 | 10, 15, 20, 25, | | N/A |
| | | | 30, 40, 50, 60, | | |
| | | | 70, 80, 90, 100 | | |
| NS_56 | 6.5.3.3.27 | n24, n99 | 5, 10 | | Clause |
| | | | | | 6.2.3.30 |
| NS_57 | NOTE 10 | n77 | 10, 15, 20, 25, | | N/A |
| | | | 30, 40, 50, 60, | | |
| | | | 70, 80, 90, 100 | | |
| NS_62 | 6.5.3.3.28 | n54 | 5 | | N/A |
| NS_100 | 6.5.2.4.2 | n1, n2, n3, | | | Table |
| | | n5, n8, n18, | | | 6.2.3.1-2 |
| | | n25, n26, | | | |
| | | n65, n66, | | | |
| | | n80, n81, | | | |
| | | n84, n86, | | | |
| | | n89 | | | |
| | | (NOTE 1) | | | |

(NOTE 1):
This NS can be signalled for NR bands that have UTRA services deployed.
(NOTE 2):
No A-MPR is applied for 5 MHz BW_{Channel} where the upper channel edge is ≥1930 MHz, 10 MHz BW_{Channel} where the upper channel edge is ≥1950 MHz and 15 MHz BW_{Channel} where the upper channel edge is ≥1955 MHz and 20 MHz BW_{Channel} where the upper channel edge is ≥1970 MHz.
(NOTE 3):
Applicable when the NR carrier is within 1447.9-1462.9 MHz.
(NOTE 4):
Applicable when the upper edge of the channel bandwidth frequency is greater than 1980 MHz.
(NOTE 5):
Applicable when the NR carrier is within 2545-2575 MHz.
NOTE 6:
This NS value is applicable for cells in the range 3450-3550 MHz for operations in the USA. This NS value does not indicate any additional spurious emission and maximum output power reduction requirements.
(NOTE 7):
The 1Tx architecture is assumed. For power class 2 UE indicating txDiversity-r16 [TS 38.306], the additional relaxation of [2] dB is applicable.
(NOTE 8):
The NS_01 label with the field additionalPmax [7] absent is default for all NR bands.
NOTE 9:
Void
NOTE 10:
This NS value is applicable for cells below 3980 MHz that are partly or fully within the range 3650-3980 MHz for operations in Canada. This NS value does not indicate any additional spurious emission and maximum output power reduction requirements.
(NOTE 11):
Applicable only for power class 1 operation.
NOTE 12:
Applicable only for power class 1 operation on band n85.
NOTE 13:
3 MHz channel bandwidth is not applicable.

### Additional Maximum Power Reduction

As an example, consider NS_05 which can be signaled for bands n1, n65, and n84. The associated emissions constraint is given by the following:

| | Channel bandwidth (MHz)/ | |
|---|---|---|
| Frequency | Spectrum emission limit (dBm) | Measurement |
| band (MHz) | 5, 10, 15, 20 | bandwidth |
| 1884.5 ≤ f ≤ 1915.7 | −41 | 300 KHz |

### Additional Requirements for “NS_05” and “NS_05U”

FIG. 5 illustrates an embodiment of an uplink spectrum, in accordance with aspects of the present disclosure. The region of the NS_05 emissions constraint 502 is shown in proximity to the n1 uplink spectrum 504.

The A-MPR that is allowed with the signaling of NS_05 is given by the following:

| | | A1 (dB) | A2 (dB) | A3 (dB) |
|---|---|---|---|---|
| Modulation/Waveform | | Outer/Inner | Outer/Inner | Outer |
| DFT-s-OFDM | Pi/2 BPSK | ≤10 | ≤5 | ≤4 |
| | QPSK | ≤10 | ≤5 | ≤4.5 |
| | 16 QAM | ≤10 | ≤5 | ≤6 |
| | 64 QAM | ≤11 | ≤5 | ≤6 |
| | 256 QAM | ≤13 | ≤5 | ≤7 |
| CP-OFDM | QPSK | ≤10 | ≤5 | ≤7.5 |
| | 16 QAM | ≤10 | ≤5 | ≤7.5 |
| | 64 QAM | ≤11 | ≤5 | ≤8 |
| | 256 QAM | ≤13 | | ≤10 |

NOTE 1:
Void
NOTE 2:
Void

### A-MPR for NS_05 and NS_05U (Power Class 3)

| | | A4 (dB) | | A5 (dB) | A6 (dB) | | A7 (dB) |
|---|---|---|---|---|---|---|---|
| Modulation/Waveform | | Outer | Inner | Outer | Outer | Inner | Outer/Inner |
| DFT-s-OFDM | Pi/2 BPSK | ≤1 | N/A | ≤1 | ≤1 | N/A | ≤6 |
| | QPSK | | | ≤1.5 | ≤1.5 | | ≤6 |
| | 16 QAM | | | | | | ≤6 |
| | 64 QAM | | | | | | ≤6 |
| | 256 QAM | | | | | | ≤6 |
| CP-OFDM | QPSK | ≤3.5 | | ≤3.5 | ≤3.5 | | ≤6 |
| | 16 QAM | ≤3.5 | | ≤3.5 | ≤3.5 | | ≤6 |
| | 64 QAM | | | | | | ≤6 |
| | 256 QAM | | | | | | ≤6 |

NOTE 1:
Void
NOTE 2:
Void

### A-MPR for NS_05 (Power Class 3)

where the regions A1-A7 are defined below:

| | Carrier | | | | | | | | | |
|---|---|---|---|---|---|---|---|---|---|---|
| Channel | Centre | | | | | | | | | |
| Band- | Frequency, | | | | | | | | | |
| width | Fc | Region A | | | Region B | | | Region C | | |
| (MHz) | (MHz) | RBₛₜₐᵣₜ | L_{CRB} | A-MPR | RBₛₜₐᵣₜ | L_{CRB} | A-MPR | RBₛₜₐᵣₜ | L_{CRB} | A-MPR |
| 5 | 1922.5 ≤ | <1.62 | >2.52 | A3 | | | | | | |
| | Fc < | MHz/12/SCS | MHz/12/SCS | | | | | | | |
| | 1927.5 | | | | | | | | | |
| 10 | 1925 ≤ | ≤1.62 | >0 | A1 | >1.62 | >5.4 | A7 | ≥7.2 | ≤1.08 | A2 |
| | Fc < | MHz/12/SCS | | | MHz/12/SCS | MHz/12/SCS | | MHz/12/SCS | MHz/12/SCS | |
| | 1935 | | | | ≤3.60 | | | | | |
| | | | | | MHz/12/SCS | | | | | |
| 10 | 1935 ≤ | | >4.5 | A4 | | | | | | |
| | Fc < | | MHz/12/SCS | | | | | | | |
| | 1945 | | | | | | | | | |
| 15 | 1927.5 ≤ | ≤3.24 | >0 | A1 | >3.24 | >8.1 | A7 | ≥10.08 | ≤1.08 | A2 |
| | Fc < | MHz/12/SCS | | | MHz/12/SCS | MHz/12/SCS | | MHz/12/SCS | MHz/12/SCS | |
| | 1932.5 | | | | ≤5.40 | | | | | |
| | | | | | MHz/12/SCS | | | | | |
| 15 | 1932.5 ≤ | <1.62 | >0 | A1 | | | | ≥12.24 | ≤1.08 | A2 |
| | Fc < | MHz/12/SCS | | | | | | MHz/12/SCS | MHz/12/SCS | |
| | 1942.5 | | | | | | | | | |
| 15 | 1942.5 ≤ | | >7.2 | A5 | | | | | | |
| | Fc < | | MHz/12/SCS | | | | | | | |
| | 1947.5 | | | | | | | | | |
| 20 | 1930 ≤ | ≤4.86 | >0 | A1 | >4.86 | >9.0 | A7 | ≥13.68 | ≤1.08 | A2 |
| | Fc < | MHz/12/SCS | | | MHz/12/SCS | MHz/12/SCS | | MHz/12/SCS | MHz/12/SCS | |
| | 1950 | | | | ≤7.20 | | | | | |
| | | | | | MHz/12/SCS | | | | | |
| 20 | 1950 ≤ | | >9.0 | A6 | | | | | | |
| | Fc < | | MHz/12/SCS | | | | | | | |
| | 1960 | | | | | | | | | |

NOTE 1:
The A-MPR values are specified in Table 6.2.3.4-2, 6.2.3.4-3, and 6.2.3.4-10.
NOTE 2:
Void

### A-MPR Regions for NS_05 and NS_05U (Power Class 3)

In one embodiment, A-MPR is allowed to meet these additional emissions requirements and the total allowed reduction of the UE output power for an RB allocation X is max(MPR(X), A-MPR(X)). If we let MPR_{Ext} denote the MPR with the use of the extended channel bandwidth, then the total allowed reduction of UE output power for an allocation X is given by max(MPR_{Ext}(X), A-MPR(X)), since the NS signaled emissions requirement is unaffected by the use of the extended channel bandwidth. However, there is a problem with this approach because in some cases, the A-MPR tables only define A-MPR values for RB allocations for which A-MPR is greater than MPR.

For an RB allocation X, let MPR(X), MPR_{Ext}(X), and A-MPR(X) denote the MPR, the MPR with the extended channel bandwidth, and the A-MPR, respectively. To address the issue in which A-MPR(X) is possibly not defined in the case that A-MPR(X)≤MPR(X), it has been proposed to address this issue by defining the total allowed reduction of UE output power for RB allocation X as max(MPR(X), MPR_{Ext} (X), A-MPR(X)).

However, this approach does not solve the problem because it is true that MPR(X)≥MPR_{Ext}(X) so that max(MPR(X), MPR_{Ext}(X), A-MPR(X))=max(MPR(X), A-MPR(X)), which is the same result as in the case that the extended channel bandwidth is not used at all. Thus, in bands with NS signaled emission requirements for which A-MPR is defined, there is no benefit in using the extended channel bandwidth unless it can be clarified if the A-MPR tables include A-MPR values for RB allocations X for which A-MPR(X)≤MPR(X).

To resolve the situation, the following is proposed:
(i) For a given NS signaled emissions constraint, the corresponding A-MPR table is considered complete if it includes A-MPR values for all RB allocations X such that A-MPR(X)>0. Alternatively, an A-MPR table can be considered complete for a threshold T if the A-MPR table includes A-MPR values for all RB allocations for which A-MPR(X)>T.
(ii) For each A-MPR table in TS 38.101-1, it must be determined whether the A-MPR Table is complete.
(iii) The specification must indicate whether or not each A-MPR is complete for the threshold T=0 or for some other agreed threshold.
(iv) The extended channel bandwidth approach cannot be used if NS is signaled and the corresponding A-MPR table is not complete. If it is not known if the A-MPR table for a given NS signaled emissions constraint is complete in the sense that A-MPR is not defined for all RB allocations X for which A-MPR(X)>0 or for which A-MPR(X)>T for some threshold T, then alternative methods can be used to define the total allowed reduction of UE power for an RB allocation X. For instance, if A-MPR is defined for an RB allocation X, then the total allowed reduction of UE output power for the RB allocation is defined as max(MPR_{Ext} (X), A-MPR(X)). However, if A-MPR is not defined for an RB allocation X, then the total allowed reduction of UE output power for the RB allocation is defined as max(MPR(X), A-MPR(X)).
(v) A-MPR tables can be modified to be complete for a threshold T=0 or for some other agreed threshold in a release independent manner so that a UE from an earlier release can use a complete A-MPR table from a later release.

It can be noted that the A-MPR (e.g., as in TS 38.101-1) is used in the definition of P_{CMAX_L,f,c} which is the lower bound on the maximum configured power of the UE. In particular, the UE is allowed to set its configured maximum output power P_{CMAX,f,c} for carrier f of serving cell c in each slot. The configured maximum output power P_{CMAX,f,c} is set within the following bounds P_{CMAX_L,f,c}≤P_{CMAX,f,c}≤P_{CMAX_H,f,c} with P_{CMAX_L,f,c}=MIN {P_{EMAX,c}−ΔT_{C,c}, (P_{PowerClass}−ΔP_{PowerClass}+ΔP_{PowerBoost})−MAX(MAX(MPR_{c}+ΔMPR_{c}, A-MPR_{c})+ΔT_{IB,c}+ΔT_{C,c}+ΔT_{RxSRS}, P-MPR_{c})} and P_{CMAX_H,f,c}=MIN {P_{EMAX,c}, P_{PowerClass}−ΔP_{PowerClass}+ΔP_{PowerBoost}}.

In order for the gNB to properly schedule the UE uplink transmission, it receives knowledge of the maximum power that the UE can transmit for a given RB allocation so that it can assign the appropriate modulation and coding rate for the uplink transmission. With knowledge of the A-MPR that can be taken by the UE for a given RB allocation, the gNB can determine the minimum value P_{CMAX_L,f,c} of the UE's maximum configured power P_{CMAX,f,c}, and this information is used by the gNB scheduler both when selecting the RB allocation for the UE and the corresponding modulation and coding rate.

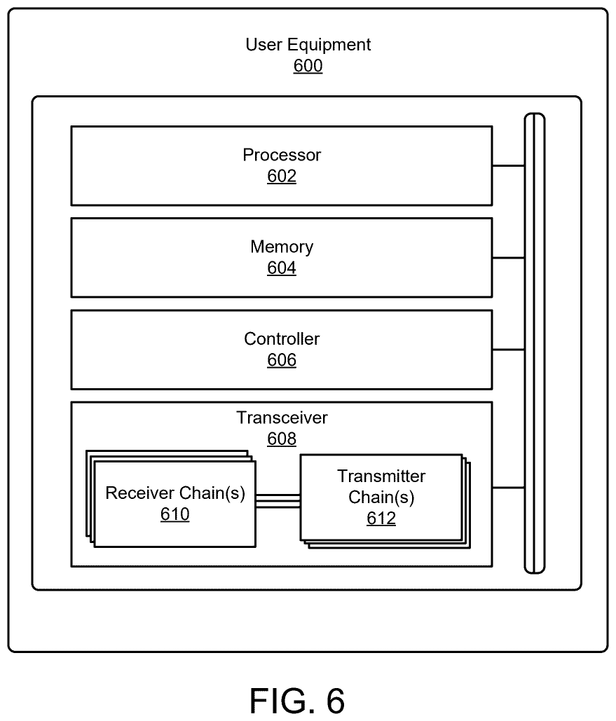

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein.

In one embodiment, the UE 600 is configured to define an extended channel bandwidth for a UE, determine one or more channel emissions constraints associated with the extended channel bandwidth, determine an additional emissions constraint, define an MPR for one or more transmissions based on the extended channel bandwidth and the one or more channel emissions constraints and an A-MPR based on the additional emissions constraint, and communicate in accordance with the MPR and the A-MPR for the one or more transmissions.

In one embodiment, the extended channel bandwidth is defined by increasing a quantity of resource blocks between at least one ACLR region and a configured channel bandwidth for the UE. In one embodiment, ACLR is measured over a bandwidth beginning at edges of the extended channel bandwidth.

In one embodiment, ACLR is measured over a bandwidth equal to a configured channel bandwidth for the UE, the extended channel bandwidth, or a combination thereof. In one embodiment, the extended channel bandwidth is larger than a configured channel bandwidth for the UE.

In one embodiment, an extension of the configured channel bandwidth for the UE is equal to one-half of a configured channel bandwidth for the UE on one or both sides of the UE channel bandwidth. In one embodiment, the extended channel bandwidth is defined as symmetric regions about a configured channel bandwidth for the UE.

In one embodiment, the extended channel bandwidth is defined as asymmetric regions about a configured channel bandwidth for the UE. In one embodiment, the extended channel bandwidth is on one side of a configured channel bandwidth for the UE. In one embodiment, the extended channel bandwidth is on both sides of a configured channel bandwidth for the UE in unequal proportions.

In one embodiment, the additional emissions constraint is associated with a table defining allowed A-MPR values. In one embodiment, the MPR for the extended channel bandwidth is applicable for a resource block allocation if the A-MPR is defined for the same resource block allocation.

In one embodiment, the table defining A-MPR values defines A-MPR for all resource block allocations where the allowed A-MPR values satisfy a threshold value. In one embodiment, the threshold value is zero decibels. In one embodiment, outer RB allocations within the extended channel bandwidth are converted to inner RB allocations to decrease the MPR.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for decoding and processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

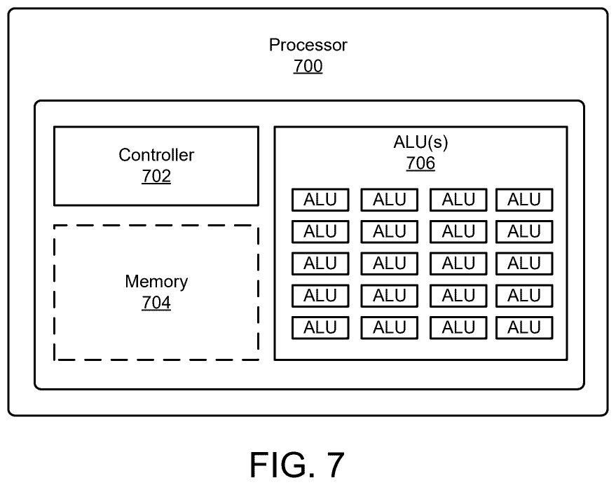

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. In one embodiment, the processor 700 is configured to define an extended channel bandwidth for a UE, determine one or more channel emissions constraints associated with the extended channel bandwidth, determine an additional emissions constraint, define an MPR for one or more transmissions based on the extended channel bandwidth and the one or more channel emissions constraints and an A-MPR based on the additional emissions constraint, and communicate in accordance with the MPR and the A-MPR for the one or more transmissions.

In one embodiment, the extended channel bandwidth is defined by increasing a quantity of resource blocks between at least one ACLR region and a configured channel bandwidth for the UE. In one embodiment, ACLR is measured over a bandwidth beginning at edges of the extended channel bandwidth.

In one embodiment, ACLR is measured over a bandwidth equal to a configured channel bandwidth for the UE, the extended channel bandwidth, or a combination thereof. In one embodiment, the extended channel bandwidth is larger than a configured channel bandwidth for the UE.

In one embodiment, an extension of the configured channel bandwidth for the UE is equal to one-half of a configured channel bandwidth for the UE on one or both sides of the UE channel bandwidth. In one embodiment, the extended channel bandwidth is defined as symmetric regions about a configured channel bandwidth for the UE.

In one embodiment, the extended channel bandwidth is defined as asymmetric regions about a configured channel bandwidth for the UE. In one embodiment, the extended channel bandwidth is on one side of a configured channel bandwidth for the UE. In one embodiment, the extended channel bandwidth is on both sides of a configured channel bandwidth for the UE in unequal proportions.

In one embodiment, the additional emissions constraint is associated with a table defining allowed A-MPR values. In one embodiment, the MPR for the extended channel bandwidth is applicable for a resource block allocation if the A-MPR is defined for the same resource block allocation.

In one embodiment, the table defining A-MPR values defines A-MPR for all resource block allocations where the allowed A-MPR values satisfy a threshold value. In one embodiment, the threshold value is zero decibels. In one embodiment, outer RB allocations within the extended channel bandwidth are converted to inner RB allocations to decrease the MPR.

In one embodiment, the processor 700 is configured to determine an allowed MPR for a UE based on an extended channel bandwidth, determine an allowed A-MPR for the UE based on additional emissions constraints, determine a lower bound on a maximum configured power for a resource block allocation based on the allowed MPR and the allowed A-MPR, and communicate the lower bound on the maximum configured power for the resource block allocation.

In one embodiment, the allowed A-MPR is based on one or more network-signaled emissions constraints. In one embodiment, the one or more network-signaled emissions constraints is associated with an allowed A-MPR table. In one embodiment, the lower bound on the maximum configured power is used to determine a modulation and coding scheme for the resource block allocation.

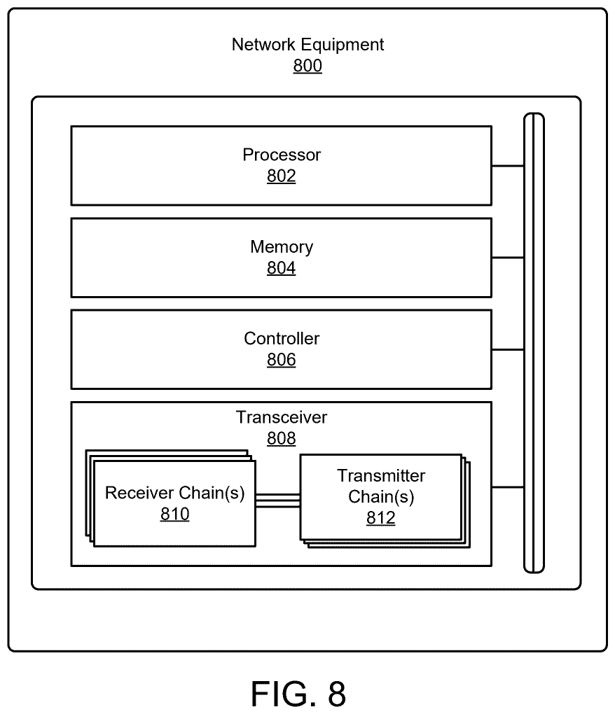

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein.

In one embodiment, the NE 800 is configured to determine an allowed MPR for a UE based on an extended channel bandwidth, determine an allowed A-MPR for the UE based on additional emissions constraints, determine a lower bound on a maximum configured power for a resource block allocation based on the allowed MPR and the allowed A-MPR, and communicate the lower bound on the maximum configured power for the resource block allocation.

In one embodiment, the allowed A-MPR is based on one or more network-signaled emissions constraints. In one embodiment, the one or more network-signaled emissions constraints is associated with an allowed A-MPR table. In one embodiment, the lower bound on the maximum configured power is used to determine a modulation and coding scheme for the resource block allocation.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding and processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

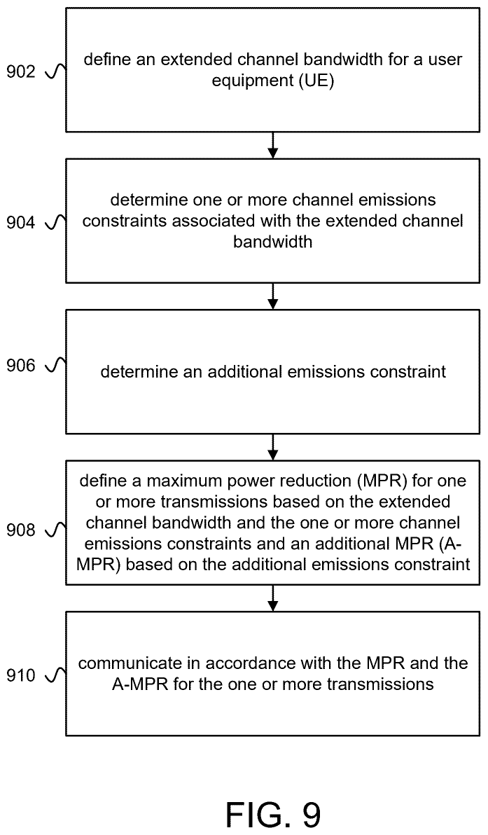

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may define an extended channel bandwidth for a UE. The operations of 902 may be performed in accordance with examples as described herein. In some implementations, aspects of the operations of 902 may be performed by a UE as described with reference to FIG. 6.

At 904, the method may determine one or more channel emissions constraints associated with the extended channel bandwidth. The operations of 904 may be performed in accordance with examples as described herein. In some implementations, aspects of the operations of 904 may be performed by a UE as described with reference to FIG. 6.

At 906, the method may determine an additional emissions constraint. The operations of 906 may be performed in accordance with examples as described herein. In some implementations, aspects of the operations of 906 may be performed by a UE as described with reference to FIG. 6.

At 908, the method may define an MPR for one or more transmissions based on the extended channel bandwidth and the one or more channel emissions constraints and an A-MPR based on the additional emissions constraint. The operations of 908 may be performed in accordance with examples as described herein. In some implementations, aspects of the operations of 908 may be performed by a UE as described with reference to FIG. 6.

At 910, the method may communicate in accordance with the MPR and the A-MPR for the one or more transmissions. The operations of 910 may be performed in accordance with examples as described herein. In some implementations, aspects of the operations of 910 may be performed by a UE as described with reference to FIG. 6.

It should be noted that the method described herein describes a possible implementation, and that the operations and the steps may be rearranged or otherwise modified and that other implementations are possible.

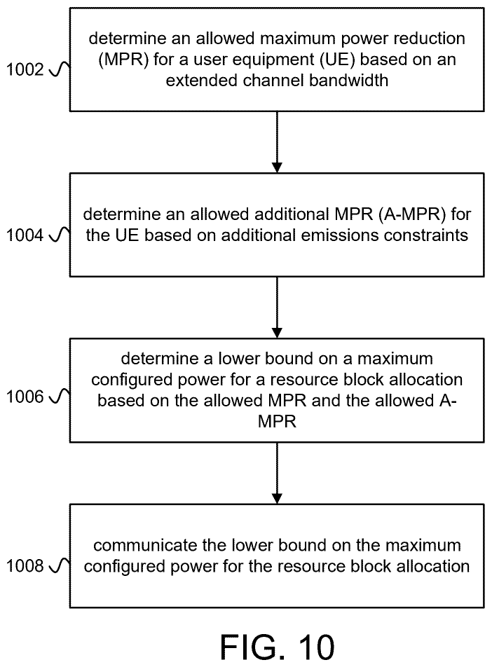

FIG. 10 illustrates a flowchart of a method in accordance with aspects of the present disclosure. The operations of the method may be implemented by a network equipment as described herein. In some implementations, the network equipment may execute a set of instructions to control the function elements of the network equipment to perform the described functions.

At 1002, the method may determine an allowed MPR for a UE based on an extended channel bandwidth. The operations of 1002 may be performed in accordance with examples as described herein. In some implementations, aspects of the operations of 1002 may be performed by a network equipment as described with reference to FIG. 8.

At 1004, the method may determine an allowed A-MPR for the UE based on additional emissions constraints. The operations of 1004 may be performed in accordance with examples as described herein. In some implementations, aspects of the operations of 1004 may be performed by a network equipment as described with reference to FIG. 8.

At 1006, the method may determine a lower bound on a maximum configured power for a resource block allocation based on the allowed MPR and the allowed A-MPR. The operations of 1006 may be performed in accordance with examples as described herein. In some implementations, aspects of the operations of 1006 may be performed by a network equipment as described with reference to FIG. 8.

At 1008, the method may communicate the lower bound on the maximum configured power for the resource block allocation. The operations of 1008 may be performed in accordance with examples as described herein. In some implementations, aspects of the operations of 1008 may be performed by a network equipment as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
define an extended channel bandwidth for the UE;
determine one or more channel emissions constraints associated with the extended channel bandwidth;
determine an additional emissions constraint;
define a maximum power reduction (MPR) for one or more transmissions based on the extended channel bandwidth and the one or more channel emissions constraints and an additional MPR (A-MPR) based on the additional emissions constraint; and
communicate in accordance with the MPR and the A-MPR for the one or more transmissions.

2. The UE of claim 1, wherein the extended channel bandwidth is defined by increasing a quantity of resource blocks between at least one adjacent channel leakage ratio (ACLR) region and a configured channel bandwidth for the UE.

3. The UE of claim 2, wherein ACLR is measured over a bandwidth beginning at edges of the extended channel bandwidth.

4. The UE of claim 3, wherein ACLR is measured over a bandwidth equal to a configured channel bandwidth for the UE, the extended channel bandwidth, or a combination thereof.

5. The UE of claim 1, wherein the extended channel bandwidth is larger than a configured channel bandwidth for the UE.

6. The UE of claim 1, wherein an extension of the configured channel bandwidth for the UE is equal to one-half of a configured channel bandwidth for the UE on one or both sides of the UE channel bandwidth.

7. The UE of claim 1, wherein the extended channel bandwidth is defined as symmetric regions about a configured channel bandwidth for the UE.

8. The UE of claim 1, wherein the extended channel bandwidth is defined as asymmetric regions about a configured channel bandwidth for the UE.

9. The UE of claim 8, wherein the extended channel bandwidth is on one side of a configured channel bandwidth for the UE.

10. The UE of claim 8, wherein the extended channel bandwidth is on both sides of a configured channel bandwidth for the UE in unequal proportions.

11. The UE of claim 1, wherein the additional emissions constraint is associated with a table defining allowed A-MPR values.

12. The UE of claim 11, wherein the MPR for the extended channel bandwidth is applicable for a resource block allocation if the A-MPR is defined for the same resource block allocation.

13. The UE of claim 11, wherein the table defining A-MPR values defines A-MPR for all resource block allocations where the allowed A-MPR values satisfy a threshold value, wherein the threshold value is zero decibels.

14. The UE of claim 1, wherein outer resource block (RB) allocations within the extended channel bandwidth are converted to inner RB allocations to decrease the MPR.

15. A processor for wireless communication, comprising:
at least one controller coupled with at least one memory and configured to cause the processor to:
define an extended channel bandwidth for the UE;
determine one or more channel emissions constraints associated with the extended channel bandwidth;
determine an additional emissions constraint;
define a maximum power reduction (MPR) for one or more transmissions based on the extended channel bandwidth and the one or more channel emissions constraints and an additional MPR (A-MPR) based on the additional emissions constraint; and
communicate in accordance with the MPR and the A-MPR for the one or more transmissions.

16. A method of a user equipment (UE), comprising:
defining an extended channel bandwidth for the UE;
determining one or more channel emissions constraints associated with the extended channel bandwidth;
determining an additional emissions constraint;
defining a maximum power reduction (MPR) for one or more transmissions based on the extended channel bandwidth and the one or more channel emissions constraints and an additional MPR (A-MPR) based on the additional emissions constraint; and
communicating in accordance with the MPR and the A-MPR for the one or more transmissions.

17. A network equipment (NE) for wireless communication, comprising:
at least one memory; and
at least one processor coupled with the at least one memory and configured to cause the NE to:
determine an allowed maximum power reduction (MPR) for a user equipment (UE) based on an extended channel bandwidth;
determine an allowed additional MPR (A-MPR) for the UE based on additional emissions constraints;
determine a lower bound on a maximum configured power for a resource block allocation based on the allowed MPR and the allowed A-MPR; and
communicate the lower bound on the maximum configured power for the resource block allocation.

18. The NE of claim 17, wherein the allowed A-MPR is based on one or more network-signaled emissions constraints.

19. The NE of claim 18, wherein the one or more network-signaled emissions constraints is associated with an allowed A-MPR table.

20. The NE of claim 17, wherein the lower bound on the maximum configured power is used to determine a modulation and coding scheme for the resource block allocation.
